(19) United States
(12) Patent Application Publication
(10) Pub. No.: US 2022/0034354 A1
(43) Pub. Date: Feb. 3, 2022

(54) TOOL FOR INSERTING AN ANTI-ROTATION SECTION OF A THREADED ROD INTO A MARGINALLY SMALLER APERTURE

(71) Applicant: COMLOCK ENTERPRISE CO., LTD., TAICHUNG (TW)

(72) Inventor: NIAN-HAO LIAO, TAICHUNG (TW)

(21) Appl. No.: 16/941,530

(22) Filed: Jul. 29, 2020

(51) Int. Cl. F16B 33/00; F16C 19/06

(52) U.S. Cl. CPC F16B 33/002; F16C 2361/00; F16C 19/06

(57) ABSTRACT

A tool for driving a threaded rod includes a shell, multiple balls and a cover. The shell includes a ring and a stepped aperture. The ring is formed on an internal face of the shell. The stepped aperture includes a first section on a side of the ring, a second section in the ring, and a third section on an opposite side of the ring. The multiple balls are inserted in the third section of the stepped aperture. The cover includes tube inserted in the first section of the stepped aperture through the second and third sections of the stepped aperture so that the cover retains the balls in the shell.

### BACKGROUND OF INVENTION

### 1. Field of Invention

The present invention relates to a threaded rod and, more particularly, to a tool for inserting an anti-rotation section of a threaded rod into a marginally smaller aperture

### 2. Related Prior Art

There are various tools for driving a threaded rod. Such tools can found in assembly lines for machines, equipment and vehicles.

Referring to FIG. 5, there is shown a workpiece such as a spacer 80. The spacer 80 is used on an axle of a vehicle to increase the wheel base of two front or rear wheels of the vehicle.

The spacer 80 includes multiple apertures 81. Multiple threaded rods 82 are fitted in the apertures 81 in a sense of direction 84. The threaded rods 82 can be moved from the apertures 81 in an opposite sense of direction 83. Each of the threaded rods 82 includes an anti-rotation section 87. A diameter of the anti-rotation sections 87 is smaller than a diameter of the apertures 81. A hammer (not shown) can be used on a side of the spacer 80 to move the threaded rods 82 from the apertures 81.

However, there is no adequate space to swing the hammer to on an opposite side of the spacer 80 to fit the threaded rods 82 in the apertures 81. Other than the hammer, a specific tool is used to fit the threaded rod 82 in the apertures 81.

Referring to FIG. 6, there is a conventional tool for inserting the anti-rotation section 87 of one of the threaded rod 82 into one of the apertures 81 of the spacer 80. The conventional tool includes a shell 90, a sealed bearing 91 and a lining 92. The shell 90 includes two sections. The first section of the shell 90 receives a sealed bearing 91. The sealed bearing 91 receives the lining 92. The second section of the shell 90 includes a conical face 93 on the inside.

In operation, a threaded rod 82 is inserted in an aperture 81 of the spacer 80. The threaded rod 82 extends into the second section of the shell 90 via the first section of the shell 90. A nut 85 is engaged with the threaded rod 82 to press a conical face 86 of the nut 85 against the conical face 93 of the shell 90. The sealed bearing 91 contacts the spacer 80 to fit the anti-rotation section 87 of the threaded rod 82 in the aperture 81 so that the threaded rod 82 is not rotatable relative to the spacer 80. In the foregoing process, the sealed bearing 91 and the lining 92 are not rotated relative to the spacer 80 because of friction. However, the nut 85 rotates the shell 90 around the threaded rod 82 because of friction.

It should be noted that two bores 94 are made in an end of the shell 90 so that the conical face 93 is located between the bores 94. Two specific tools (not shown) can be inserted in the bores 94 to push the sealed bearing 91 out of the shell 90 if necessary.

However, the use of this tool is not without any problems. Firstly, the sealed bearing 91 is expensive. Secondly, it is difficult to fit the sealed bearing 91 in the shell 90. Thirdly, it is troublesome to insert the lining 92 in the bearing 91 and the shell 90.

The present invention is therefore intended to obviate or at least alleviate the problems encountered in the prior art.

### SUMMARY OF INVENTION

It is the primary objective of the present invention to provide an inexpensive and robust tool for inserting an anti-rotation section of a threaded rod into a marginally smaller aperture in a workpiece.

To achieve the foregoing objective, the tool includes a shell, multiple balls and a cover. The shell includes a ring and a stepped aperture. The ring is formed on an internal face of the shell. The stepped aperture includes a first section on a side of the ring, a second section in the ring, and a third section on an opposite side of the ring. The multiple balls are inserted in the third section of the stepped aperture. The cover includes tube inserted in the first section of the stepped aperture via the second and third sections of the stepped aperture so that the cover retains the balls in the shell.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a tool for inserting an anti-rotation section of a threaded rod into a marginally smaller aperture in a workpiece according to the preferred embodiment of the present invention;

FIG. 2 is a cut-away view of the tool shown in FIG. 1 together with a workpiece and a threaded rod;

FIG. 3 is a cut-away view of the tool, the workpiece and the threaded rod shown in FIG. 2;

FIG. 4 is a cross-sectional view of the tool, the workpiece and the threaded rod shown in FIG. 3;

FIG. 5 is a perspective view of a spacer to be used on an axle of a vehicle; and

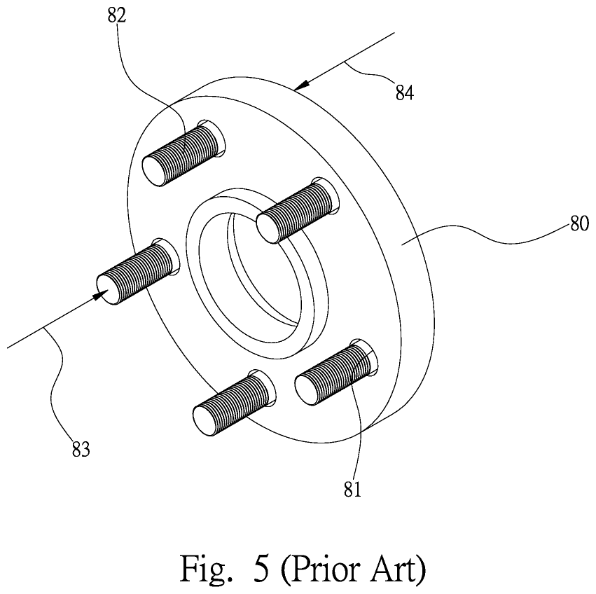

FIG. 6 is a cut-away view of a conventional tool for driving a threaded rod into the spacer shown in FIG. 5.

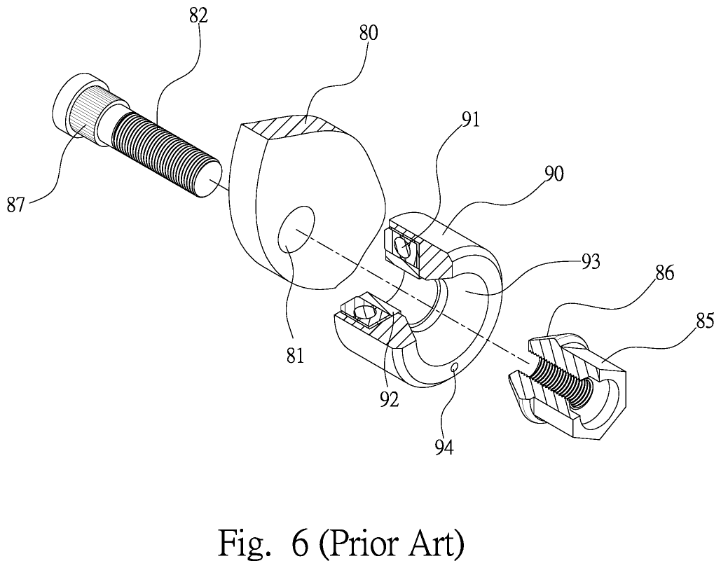

### DETAILED DESCRIPTION OF PREFERRED EMBODIMENT

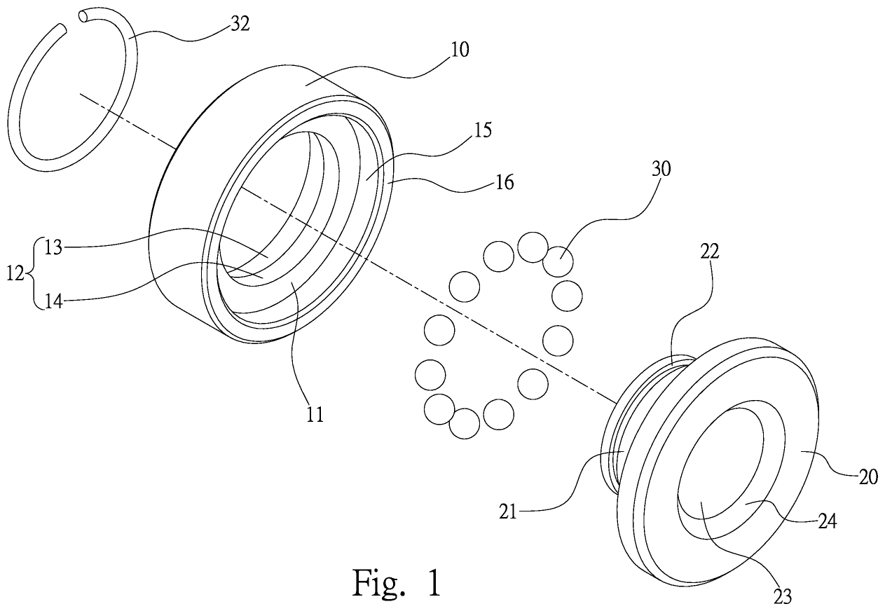

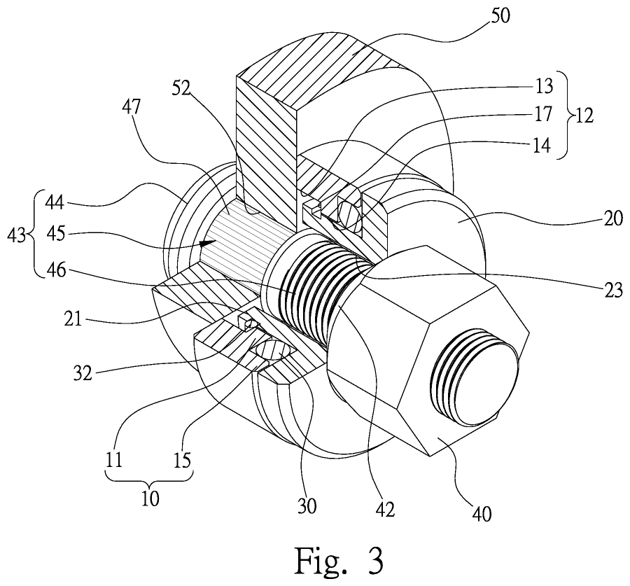

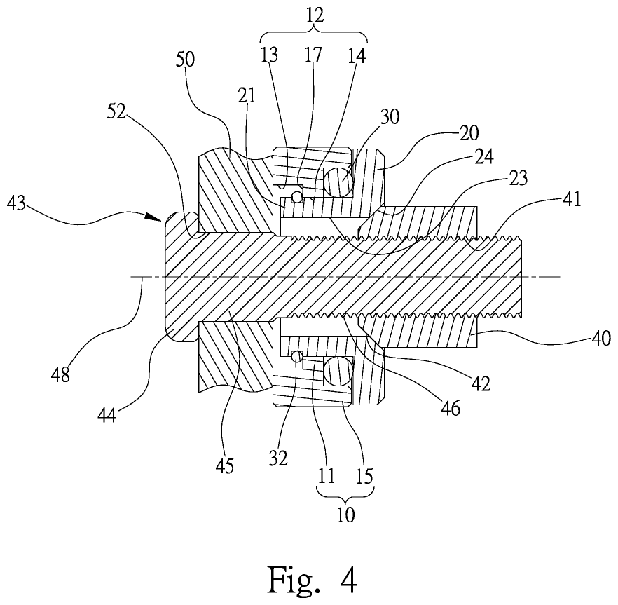

Referring to FIGS. 1 through 4, there is a tool for inserting an anti-rotation section 45 of a threaded rod 43 into a marginally smaller aperture 52 in a workpiece 50 in accordance with the preferred embodiment of the present invention. The tool includes a shell 10, a cover 20, multiple balls 30 and a C-clip 32

The shell 10 includes a ring 11 formed on an internal face of an annular body 15. The shell 10 includes a stepped aperture 12 about which the internal face of the annular body 15 extends. The space of the shell 10 includes a medium section 13 on a side of the ring 11, a small section 14 in the ring 11, and a large section 16 on an opposite side of the ring 11. The sections 13, 14 and 16 are coaxial and in communication with one another. There is a shoulder 17 between the sections 13 and 14.

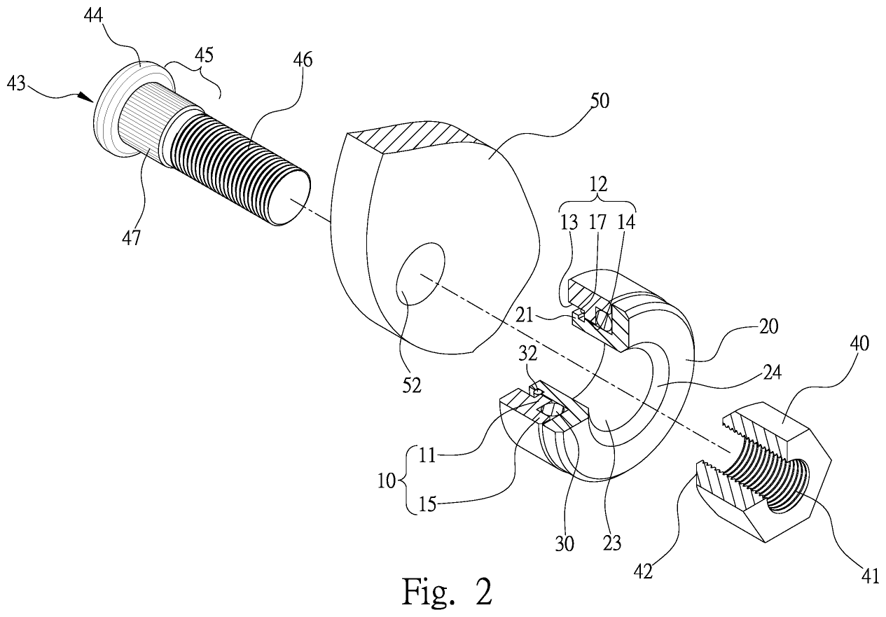

Referring to FIG. 2, the cover 20 is an annular element that includes a tube 21 extending from a side. The tube 21 includes a groove 22 in an external face and an axial aperture 23 in an internal face. The aperture 23 is defined by a cylindrical face that includes a conical face 24.

In assembly, the balls 30 are inserted in the large section 16 of the stepped aperture 12. The tube 21 is inserted into the medium section 13 through the small section 14 and the large section 16. The clip 32 is inserted in the groove 22. Thus, the tube 21 is kept in the shell 10. The cover 20 covers an end of the annular body 15 of the shell 10. The balls 30 are kept in the large section 16 of the stepped aperture 12 by the cover 20. The balls 30 are in contact with the annular body 15 and the ring 11 of the shell 10 and the cover 20.

The tool is used with a nut 40 to drive the threaded rod 43 through an aperture 52 of a workpiece 50. The nut 40 includes a thread 41 formed on an internal face and a conical face 42 at an end. The threaded rod 43 includes an enlarged head 44 at an end, an anti-rotation section 45 formed next to the enlarged head 44 and a thread 46 formed next to the anti-rotation section 45. The anti-rotation section 45 of the threaded rod 43 is formed with multiple rectilinear ribs 47.

The nut 40 is located on a side of the workpiece 50 and the threaded rod 43 is located on an opposite side of the workpiece 50. The tool is located between the workpiece 50 and the nut 40. The thread 46 is inserted into the stepped aperture 12 of the shell 10 via the aperture 52 of the workpiece 50. A user uses bare hands to rotate the nut 40 relative to the threaded rod 43 to engage the thread 46 of the threaded rod 43 with the thread 41 of the nut 40. The user continues to use the bare hands to rotate the nut 40 relative to the threaded rod 43 to move the threaded rod 43 toward the nut 40 along an axis 48. Eventually, the user uses the bare hands to bring the anti-rotation section 45 of the threaded rod 43 into contact with the workpiece 50 and the conical face 42 of the nut 40 into contact with the conical face 24 of the cover 20. Then, the user uses a wrench (not shown) to continue to rotate the nut 40 relative to the threaded rod 43, which is not rotated due to friction of the anti-rotation section 45 with the workpiece 50, to force the anti-rotation section 45 of the threaded rod 43 in the aperture 52 of the workpiece 50.

The cover 20 retains the balls 30 in the large section 16 of the stepped aperture 12 of the shell 10. The number of elements of the tool is relatively small, the structure of the tool is relatively simple, and the cost of the tool is relatively low.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A tool for inserting an anti-rotation section of a threaded rod into a marginally smaller aperture in a workpiece, the tool comprising:
a shell comprising a ring formed on an internal face and a stepped aperture comprising a first section on a side of the ring, a second section in the ring, and a third section on an opposite side of the ring;
multiple balls inserted in the third section of the stepped aperture; and
a cover comprising a tube inserted in the first section of the stepped aperture via the second and third sections of the stepped aperture so that the cover retains the balls in the shell.

2. The tool according to claim 1, comprising a C-clip, wherein the tube comprises a groove for receiving the C-clip.

3. The tool according to claim 2, wherein the shell comprises a shoulder formed between the first and second sections of the stepped aperture, wherein the C-clip is abutted against the shoulder to keep the tube in the shell.

4. The tool according to claim 1, wherein the cover comprises a conical face opposite to the tube, wherein the conical face is adaptable for contact with a conical face of a nut.
